(19) United States
(12) Patent Application Publication
(10) Pub. No.: US 2025/0168751 A1
(43) Pub. Date: May 22, 2025

(54) METHODS AND DEVICES FOR HANDLING INTER-FREQUENCY MEASUREMENTS ON NEIGHBORING NTN CELLS

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 18/841,196

(22) PCT Filed: Sep. 27, 2023
(86) PCT No.: PCT/US2023/033813

§ 371 Date: Aug. 23, 2024

Related U.S. Application Data
(60) Provisional application No. 63/377,725, filed on Sep. 30, 2022.
(60) Provisional application No. 63/377,708, filed on Sep. 29, 2022.

(51) Int. Cl. H04W 48/12; H04W 24/10; H04W 36/08; H04W 48/16; H04W 84/06

(52) U.S. Cl. CPC H04W 48/12; H04W 24/10; H04W 36/08; H04W 48/16; H04W 84/06

(57) ABSTRACT

A user equipment is configured to conduct an intra-frequency measurement on a candidate frequency of a non-terrestrial network (NTN) cell even when the UE does not receive information about measurement timing within a candidate frequency configuration or pertinent satellite ephemeris information via a neighbor NTN cell configuration. The UE operates based on the assumption that a base station preparing lists of frequency configurations and neighbor NTN cell configurations has reduced redundant information (e.g., when the same satellite provides plural non-terrestrial cells). The base station is configured to prepare and broadcast such reduced lists of frequency configurations and neighboring NTN cell configurations providing information for the intra-frequency measurements.

This document relates generally to wireless communications and, more particularly, to a user equipment (UE) performing inter-frequency measurements on neighboring non-terrestrial network (NTN) cells.

### BACKGROUND

This background description is provided for the purpose of generally presenting the context of inter-frequency measurements. Work of the presently named inventors, to the extent it is described in this background section, as well as aspects of the description that does not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Things (NB-IoT) or the enhanced Machine Type Communication (eMTC) scenarios. In an NTN, an RF transceiver is mounted on a satellite, an uncrewed aircraft systems (UAS) also called drone, balloon, plane, or another suitable apparatus. For simplicity, the discussion below refers to all such apparatuses as satellites. In addition to satellites, an NTN can include one or more satellite gateways (called “sat-gateway” or “NTN gateway”) that connects the NTN to a public data network, feeder links between sat-gateways and satellites, service links between satellites, and inter-satellite links (ISL) when satellites form constellations.

A satellite can belong to one of several types based on altitude, orbit, and beam footprint characteristics. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, which have a nearly stationary beam footprint, and LEO/MEO satellites are also known as the non-GSO (NGSO) satellites that have a time-dependent beam footprint.

A GSO satellite can communicate with one or several sat-gateways deployed over the GSO satellite's coverage area (e.g., a region or even a continent). A non-GSO satellite at different times can communicate with one or several serving sat-gateways. An NTN is designed to ensure service and feeder link continuity between successive serving sat-gateways, with sufficient time duration to proceed with mobility anchoring and hand-over.

A satellite can transmit a transparent or a regenerative (with on board processing) payload, and typically generates several beams for a given service area bounded by the field of view (i.e., satellite's coverage area). The footprints of the beams (i.e., NTN cells) typically have an elliptic shape and depend on the on-board antenna configuration and the elevation angle. For a transparent payload, the satellite may apply RF filtering, frequency conversion and amplification, but does not change the waveform signal. For a regenerative payload, the satellite may apply RF filtering, frequency conversion, amplification, demodulation and decoding, routing, and coding/modulation. A satellite performing all these functions is effectively equivalent to a base station (e.g., a gNB).

A UE can experience significant signal propagation delay differences while communicating via different satellites. These differences requires the UE to adjust the measurement timing configured for the service cell when performing measurements on neighboring NTN cells. When an adjustment is made based on the distance between the UE and the sat-gateway via a satellite employed in delivering the signals to be measured, the UE needs to acquire ephemeris information of this satellite. The UE receives the configured measurement timing and the satellite's ephemeris information separately in different system information blocks (SIBs). These pieces of information are linked/paired with each other by referring to the same carrier frequency. If the UE is unable to find the link between the configured measurement timing and the satellite ephemeris information, the UE does not know how to adjust the configured measurement timing and hence may fail to perform the neighboring NTN cell measurement.

Moreover, an idle or inactive UE may frequently conduct measurements of neighboring cells that use frequencies associated with higher-priority than the frequency used by the serving cell (e.g., such a higher-priority assignment being made for load-balancing purpose). These measurements waste UE's power when the UE is not within the area served by such a neighboring cell. As an NTN cell is typically larger and less overlapped with neighboring cells (compared to a TN cell), there could be many UEs consuming their power in measuring the neighboring cells that do not cover these UEs. Because measuring a higher-priority frequency is a background routine that a UE performs, configuring a higher-priority frequency using the broadcast manner might results in severe power waste for many UEs.

### SUMMARY

The techniques described in this document allow a UE in idle/inactive state to conduct an inter-frequency measurement (e.g., for cell reselection) on a candidate frequency specified only in a list of frequency configurations or only in a list of neighboring NTN cell configurations. The network entity (NE, e.g., a base station, BS) preparing the list of frequency configurations and/or the list of neighboring cell configurations can optimize the lists' content (thus reducing signaling overhead) by omitting redundant information. A UE, while operating in idle/inactive mode, is configured to perform the inter-frequency measurements in spite of the missing information, omitted from the frequency configurations and/or neighbor cell configurations, thus the UE supports reduction of the lists' content.

Additionally or alternatively, a UE is configured to restrict inter-frequency measurements of neighboring NTN cell signals associated with a higher-priority frequency than serving cell's frequency, while the UE's location is not within coverage area of the neighboring NTN cell. The UE is enabled to assess whether the UE's location is within the coverage area of the neighboring NTN cell by additional information (e.g., a radius around a neighbor cell's center) included in the neighboring NTN cell configuration.

NEs (e.g., BSs) and UEs performing an inter-frequency measurement as specified above (e.g., on a neighboring NTN cell frequency specified only in the neighboring NTN cell configurations or only in the frequency configurations) include at least one processor, a transceiver, and a computer readable medium.

### BRIEF DESCRIPTION OF THE DRAWINGS

FIG. 1A is a block diagram of a wireless communication system including a UE and an NE configurable to handle inter-frequency measurements according to following embodiments.

FIG. 1B is a block diagram of a distributed network entity (e.g., BS) that can operate in the system illustrated in FIG. 1A.

FIG. 2A is a block diagram of a protocol stack usable by the UE of FIG. 1A communicate with BSs.

FIG. 2B is a block diagram of a protocol stack usable by the UE of FIG. 1A to communicate with a CU and a DU.

FIG. 3A is a schematic illustration of an NTN node operating with transparent payload implementation.

FIG. 3B is a schematic illustration of an NTN node operating with transparent payload implementation, in which a BS connects to multiple satellites via the same NTN gateway.

FIG. 4A illustrates a user plane protocol stack usable in the setup illustrated in FIG. 3A.

FIG. 4B illustrates a control plane protocol stack usable in the setup illustrated in FIG. 3A.

FIG. 5 is a messaging diagram of a scenario in which the UE receives measurement timing of the serving cell (e.g., SS/PBCH block Measurement Timing Configuration, SMTC), adjusts the measurement timing for a neighboring NTN cell, and conducts the inter-frequency measurement on the neighboring cell based on the adjusted measurement timing.

FIG. 6 illustrates a setup in which the UE experiences different propagation delays while communicating via different satellites and thus different NTN cells.

FIG. 7A illustrates a setup in which the same satellite generates different frequency beams for two adjacent NTN cells (i.e., each of the NTN cells is a neighbor cell to the other NTN cell).

FIG. 7B illustrates a setup in which each of two different satellites generates a beam for an NTN cell, the beams using different frequencies and the NTN cells being adjacent (i.e., neighbor to one another).

FIG. 8 illustrates a setup in which an operator attempts to balance cell loads among three partially overlapping cells by setting higher priorities for cells serving more users in a geographic area.

FIG. 9 is a messaging diagram of an embodiment operating in the setup illustrated in FIG. 7A, with an idle/inactive UE conducting a measurement on a carrier frequency that is not included in the neighboring NTN cell configuration.

FIG. 10 is a messaging diagram of an embodiment operating in the setup illustrated in FIG. 7B, with an idle/inactive UE conducting a measurement on a carrier frequency that is not included in the list of frequency configurations but it is associated to a neighboring NTN cell configuration.

FIG. 11 is a messaging diagram of an embodiment operating in the setup illustrated in FIG. 8, with an idle/inactive UE conducting a measurement on a higher-priority frequency (higher than the priority of the serving frequency) only if the UE is located within the neighboring cell using that higher-priority frequency.

FIG. 12 is a flow diagram of a method according to which a UE (e.g., the one in FIG. 9) is able to conduct a measurement on a carrier frequency not included in any neighboring NTN cell configuration.

FIG. 13 is a flow diagram of a method according to which a UE (e.g., the one in FIG. 10) is able to conduct a measurement on a carrier frequency that is not included in the frequency configurations.

FIG. 14 is a flow diagram of a method according to which a UE (e.g., the one in FIG. 11) conducts a measurement on a higher-priority frequency (higher than the priority of the serving frequency) depending on whether the UE is located within the higher-priority cell's coverage.

FIG. 15 is a flow diagram of a method according to which an NE (e.g., a BS such as the one in FIG. 9) may reduce the contents of the list of neighboring NTN cell configurations.

FIG. 16 is a flow diagram of a method according to which an NE (e.g., a BS such as the one in FIG. 10) may reduce the contents of the list of the frequency configurations.

FIG. 17 is a flow diagram of a method according to which an NE (e.g., a BS such as the one in FIG. 11) includes cell measurement area information in the list of neighboring NTN cell configurations.

### DETAILED DESCRIPTION OF THE DRAWINGS

As discussed in more detail below, a user equipment (UE) and/or a network node of a radio access network (RAN) can use the techniques described in this section for handling inter-frequency measurements on neighboring NTN cells.

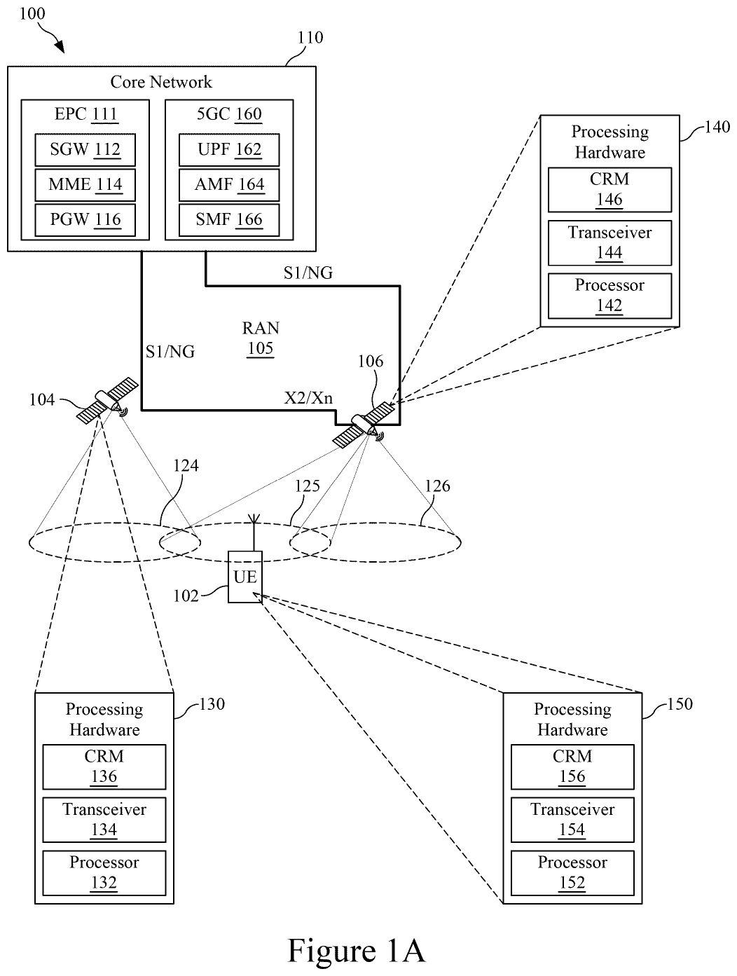

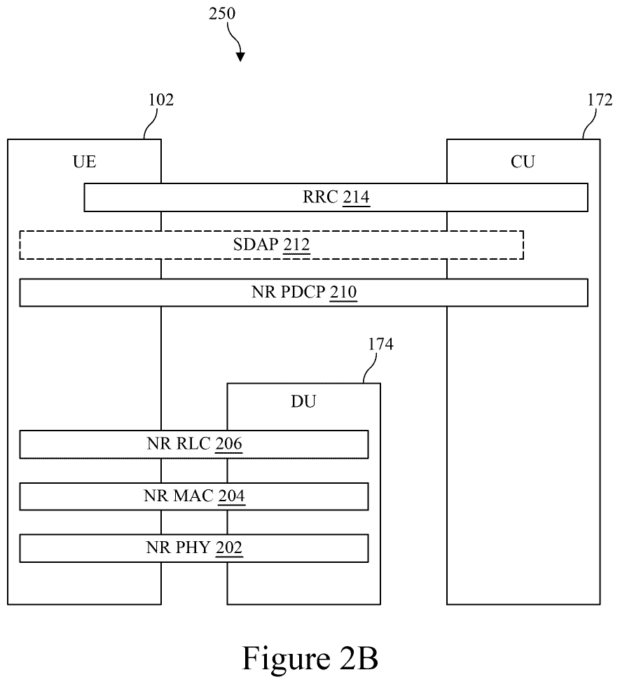

Referring first to FIG. 1A, an example wireless communication system 100 includes a UE 102, a base station (BS) that communicates with UE 102 via satellite (therefore represented in this figure as a satellite icon but the setup is illustrated in more detail in FIG. 3A), a BS 106 that also communicates via satellite, and a core network (CN) 110. The BSs 104 and 106 can operate in a RAN 105 connected to the core network (CN) 110. The CN 110 may be implemented as an evolved packet core (EPC) 111 or a fifth generation (5G) core (5GC) 160 (both illustrated in FIG. 1A, but it is not required both be present). The CN 110 may also include a sixth generation (6G) core (not shown).

The BS 104 may communicate with the UE 102 via a cell 124, and the BS 106 may communicate with the UE 102 via a cell 125 or a cell 126. If the BS 104 is a gNB, the cell 124 is an NR cell. If the BS 104 is an ng-eNB or eNB, the cell 124 is an evolved universal terrestrial radio access (E-UTRA) cell. Similarly, if the BS 106 is a gNB, the cells 125 and 126 are NR cells, and if the BS 106 is an ng-eNB or eNB, the cells 125 and 126 are E-UTRA cells. The cells 124, 125 and 126 may be in the same Radio Access Network Notification Areas (RNA) or different RNAs. In general, the RAN 105 may include any number of BSs, with each of the BSs able to communicate with UEs via one or more cells. The UE 102 supports at least a 5G NR (or simply, “NR”) or an E-UTRA air interface to communicate with the BSs 104 and 106. Each of the BSs 104, 106 may connect to the CN 110 via an interface (e.g., S1 or NG interface). The BSs 104 and 106 also may be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 is configured to transfer user-plane packets related to audio calls, video calls, Internet traffic, etc., and the MME 114 is configured to manage authentication, registration, paging, and other related functions. The PGW 116 provides to UEs connectivity to one or more external packet data networks, e.g., an Internet network and/or an Internet Protocol (IP) Multimedia Subsystem (IMS) network.

The 5GC 160 includes a User Plane Function (UPF) 162, an Access and Mobility Management Function (AMF) 164, and/or Session Management Function (SMF) 166. The UPF 162 is configured to transfer user-plane packets related to audio calls, video calls, Internet traffic, etc., the AMF 164 is configured to manage authentication, registration, paging, and other related functions, and the SMF 166 is configured to manage packet data unit (PDU) sessions.

As illustrated in FIG. 1A, the cells 124 and 125 as well as the cells 125 and 126 partially overlap, so that the UE 102 may select, reselect, or hand over from one of the cells to the other. To directly exchange messages or information, the BS 104 and BS 106 may support an X2 or Xn interface. In general, the CN 110 may connect to any suitable number of BSs supporting new radio (NR) cells and/or E-UTRA cells. E-UTRA is usually associated with 3GPP Long Term Evolution (LTE) radio access technology (RAT) and NR is usually associated with 5G RAT.

The UE 102 and/or the BSs 104 and 106 may utilize the techniques described in this section when the UE 102 operates in an inactive or idle state of the protocol for controlling radio resources (i.e., Radio Resource Protocol, RRC) between the UE 102 and the core network 110 (i.e., the RRC_INACTIVE or RRC_IDLE state of the RRC protocol).

The BS 104 is equipped with processing hardware 130 that includes a processor 132 (but may include more than one general-purpose processors, e.g., CPUs), a transceiver 134 and a non-transitory computer-readable medium (CRM) 136, such as a memory. Additionally or alternatively, the processing hardware 130 may include special-purpose processing units. The processor 132 is configured to process data that the BS 104 transmits in the downlink direction to the UE 102, and/or to process data that the BS 104 receives in the uplink direction from the UE 102. The transceiver 134 may include a transmitter configured to transmit data in the downlink direction, and a receiver configured to receive data in the uplink direction. The CRM 136 stores executable instructions that the processor 132 executes to perfom various techniques described in this section. The BS 106 includes similar components as the BS 104. In other words, the components 140, 142, 144, and 146 of the BS 106 are similar to the components 130, 132, 134, and 136 of the BS 104, respectively.

The UE 102 is equipped with processing hardware 150 that includes at least one processor 152 (but it may include more than one general-purpose processors, such as CPUs, and/or special-purpose processing units), a transceiver 154 and a non-transitory computer-readable medium (CRM) 156, such as a memory. The processor 152 is configured to process data that the UE 102 transmits in the uplink direction, and/or to process data received by UE 102 in the downlink direction. The transceiver 154 may include a transmitter configured to transmit data in the downlink direction, and a receiver configured to receive data in the uplink direction. The CRM 156 stores executable instructions that the processor 152 executes to perfom various techniques described in this section.

FIG. 1B is a block diagram of a distributed BS 170 that may operate as BS 104 or 106 in the system illustrated in FIG. 1A. The BS 170 includes a central unit (CU) 172 and at least one distributed unit (DU) 174. Each CU and DU includes processing hardware, such as one or more general-purpose processors (e.g., CPUs) and/or special-purpose processing units, a transceiver and a CRM storing machine-readable instructions executable on by the processor(s). A DU or a CU may operate in the system illustrated in FIG. 1A instead of a BS. The CU may operate as a packet data convergence protocol (PDCP) controller, an RRC controller and/or an RRC inactive controller. The CU may also operate as a radio link control (RLC) controller configured to manage or control one or more RLC operations or procedures. The DU may operate as a media access control (MAC) controller configured to manage or control one or more MAC operations or procedures (e.g., a random access procedure), an RLC controller configured to manage or control one or more RLC operations or procedures, and/or a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

The CU 172 may include a logical node CU-CP 172A that hosts the control plane part of the PDCP protocol of the CU 172. The CU 172 may also include logical node(s) CU-UP 172B that hosts the user plane part of the PDCP protocol and/or Service Data Adaptation Protocol (SDAP) protocol of the CU 172. The CU-CP 172A may transmit control information (e.g., RRC messages, F1 application protocol messages), and the CU-UP 172B may transmit the data packets (e.g., SDAP PDUs or Internet Protocol packets). The CU-CP 172A may be connected to multiple CU-UP (such as CU-UP 172B) through the E1 interface. The CU-CP 172A selects the appropriate CU-UP 172B for the requested services for the UE 102. In some implementations, a single CU-UP (such as CU-UP 172B) may connect to multiple CU-CP (such as CU-CP 172A) through the E1 interface. The CU-CP 172A may connect to one or more DUs (such as DU 174) through an F1-C interface. The CU-UP 172B may connect to one or more DUs (such as DU 174) through the F1-U interface under the control of the same CU-CP 172A. In some implementations, one DU (such as DU 174) may connect to multiple CU-UP 172B under the control of the same CU-CP 172A. In such implementations, the connectivity between a CU-UP and a DU is established by the CU-CP using Bearer Context Management functions.

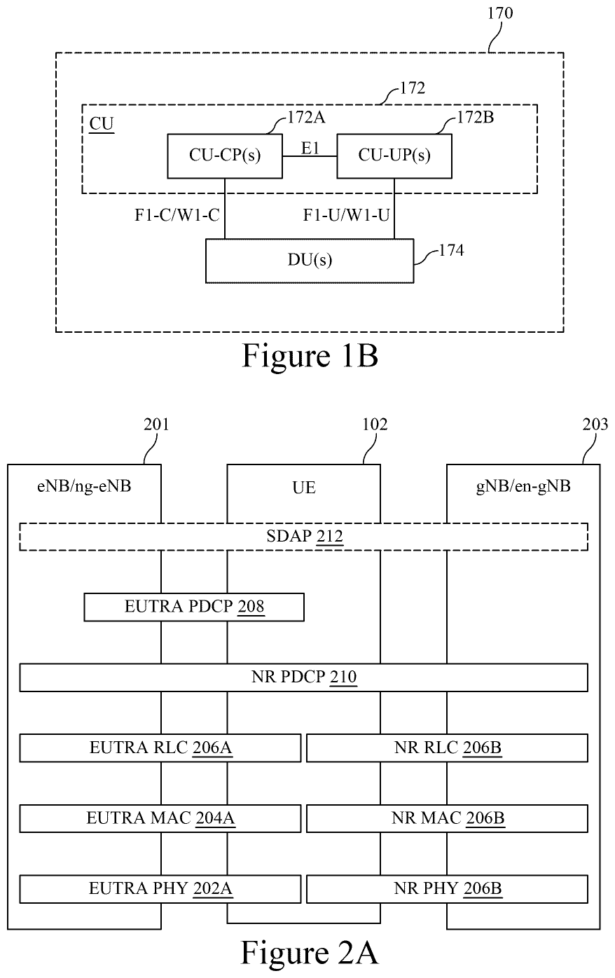

FIG. 2A illustrates, in a simplified manner, a protocol stack which the UE 102 may employ to communicate with an eNB/ng-eNB 201 and/or a gNB/en-gNB 203 (where 201 and 203 may be BS 104 or 106 in FIG. 1A). The protocol stack may include a EUTRA physical layer (PHY) 202A that provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn may provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR BSs and/or to support DC over EUTRA and NR interfaces. Further, as illustrated in FIG. 2A, the UE 102 may support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that may be referred to as service data units (SDUs), and output packets (e.g., to the RLC layer 206A or 206B) that may be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 may provide signaling radio bearers (SRBs) or an RRC sublayer (not shown in FIG. 2A) to exchange RRC messages or non-access-stratum (NAS) messages. On a user plane, the EUTRA PDCP sublayer 208 and the NR PDCP sublayer 210 may provide Data Radio Bearers (DRBs) to support data exchange. Data exchanged on the NR PDCP sublayer 210 may be SDAP PDUs, IP packets or Ethernet packets.

FIG. 2B illustrates, in a simplified manner, a protocol stack, which the UE 102 may employ to communicate with a DU (e.g., DU 174) and a CU (e.g., CU 172). The radio protocol stack in FIG. 2A is functionally split similarly to the functional split of the radio protocol stack in FIG. 2B. The CU at any of the BSs 104 or 106 may hold the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

FIG. 3A is a schematic illustration of an NTN node operating with in a transparent payload architecture. A satellite (NTN) gateway 302 and a “transparent” satellite 304 extend the range of BS 104's Uu interface. The satellite 304 implements a frequency conversion and a Radio Frequency (RF) amplifier in both the uplink and downlink directions. The satellite function is similar to that of an analogue RF repeater. As a result, the satellite 304 repeats the Uu radio interface signals transmitted via the feeder link (between the NTN gateway and the satellite) and then the service link (between the satellite and the UE) in the downlink direction and vice versa in the uplink direction. The Satellite Radio Interface (SRI) of the feeder link is the Uu, and the NTN gateway 302 supports all necessary functions to forward the signal of the Uu interface. The NTN gateway 302 may be collocated with the BS (e.g., eNB, gNB) 104, or may be connected to the BS 104 via a wired link. It is also possible to have more than one NTN gateway conneted to a BS. Different transparent satellites such as 304 may be connected to the same terrestrial BS via the same NTN gateway, or via different NTN gateways. FIG. 3B illustrates the case where two different satellites (304 and 306) are connected to the same BS 104 via the same NTN gateway 302. These two satellites (304 and 306) emit beams to the Earth surface for two NTN cells with two different Physical Cell IDs (PCIs).

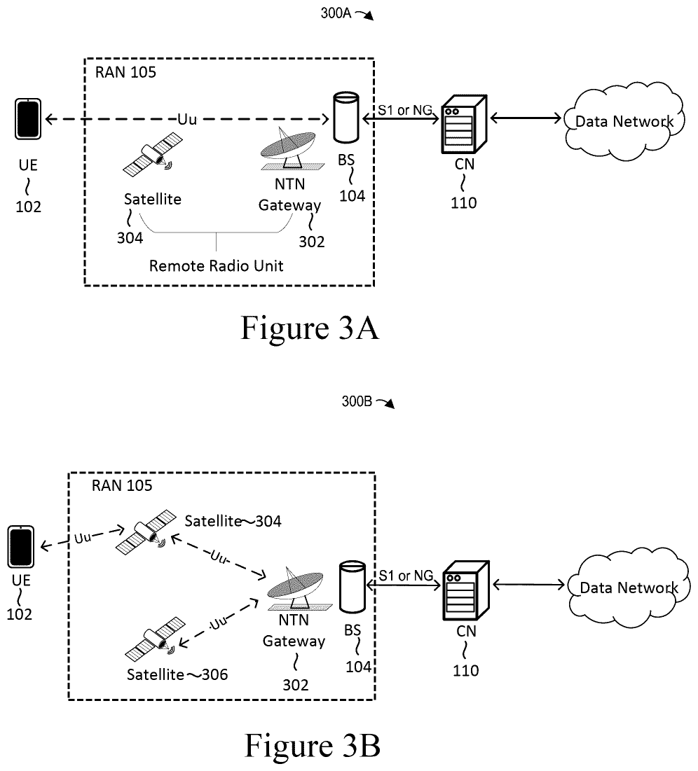

FIG. 4A illustrates an NTN user plane protocol stack (UPPS) employed by the UE 102, the satellite 304, the NTN gateway 302, the NR BS (i.e., gNB) 104, and the UPF 114. This NTN user plane protocol stack is similar to that of the terrestrial network (TN) UPPS, with the addition of two new nodes (i.e., the satellite 304 and the NTN gateway 302) in the middle of the NR-Uu interface. Similarly, the NTN control plane protocol stack illustrated in FIG. 4B is also similar to that of the terrestrial network. The UE-to/from-gNB communications employ physical layer 402, MAC layer 404 and Radio Link Control, RLC, layer 406. Further, the UE-to/from-gNB communications employ a packet Data Convergence Protocol, PDCP, 408 and a Service Data Adaptation Protocol, SDAP, 410. The gNB-to/from-UPF communications employ an L1 layer 401 (i.e., 5G Physical Layer), an L2 layer 402 (i.e., 5G Data Link Layer) and an Internet Protocol, IP, 405. Further, the gNB-to/from-UPF communications employ a User Datagram Protocol, UDP, 407 and a GPRS Tunnelling Protocol, for carrying user data, GTP-U 409 (here acronym GPRS stands for General Packet Radio Services).

FIG. 4B illustrates an NTN control plane protocol stack, CPPS, which is also similar to that of the TN CPPS. The differences between the UPPS in FIG. 4A and the CPPS in FIG. 4B are now discussed. Instead of SDAP 410 in the NTN UPPS, the NTN CPPS includes an RRC layer 411. Additionally, the UDP 407 and the NGAP 409 in the NTN UPPS are replaced with the Stream Control Transmission Protocol, SCTP, 413, and the Next Generation Application Protocol, NGAP, 414. These protocols and communication layers are described in contemporaneous 3GPP technical specifications.

In terms of the satellite moving pattern, NTNs support three types of service links:
Earth-fixed: provisioned by beam(s) continuously covering the same geographical areas all the time (e.g., the case of GEO/GSO satellites)
Quasi-Earth-fixed: provisioned by beam(s) covering one geographic area for a limited period and a different geographic area during another period (e.g., the case of LEO/MEO satellites capable of using steerable beams)
Earth-moving: provisioned by beam(s) whose coverage area slides over the Earth surface (e.g., the case of LEO/MEO satellites using fixed or non-steerable beams).

With LEO/MEO satellites, the eNB can provide either quasi-Earth-fixed cell coverage or Earth-moving cell coverage. With GEO satellites, the eNB can provide Earth fixed cell coverage.

Although the transparent payload architecture illustrated in FIGS. 3A/3B is the current focus of the 3GPP development, the regenerative payload architecture that installs the BS functions on the satellite is also a possible NTN deployment in the future. In such an architecture, the Uu only exists between the satellite and the UE. The techniques described in this section may be used for the transparent payload architecture as well as the regenerative payload architecture.

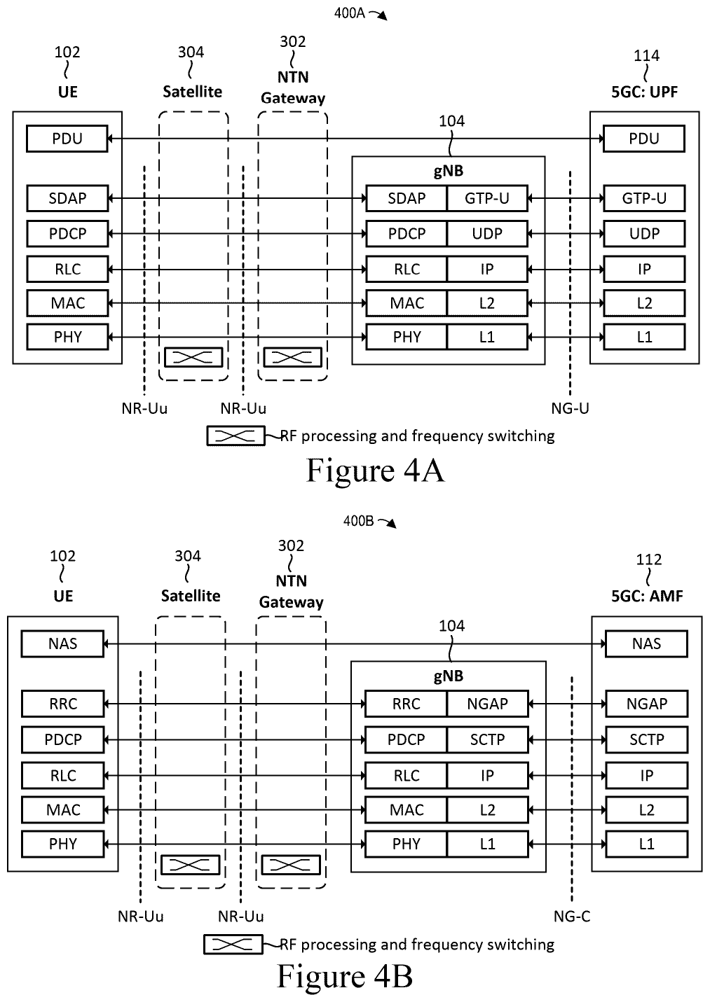

FIG. 5 is a messaging diagram of a scenario in which the UE receives measurement timing of the serving cell (e.g., SS/PBCH block Measurement Timing Configuration, SMTC, with SS indicating synchronization signals such as the primary synchronization signal, and the secondary synchronization signal and PBCH being the achonym of physical broadcast channel), adjusts the measurement timing for a neighboring NTN cell, and conducts the inter-frequency measurement on the neighboring cell based on the adjusted measurement timing.

The UE 102 initially operates 502 in a connected state and communicates with the BS 104 via a service link provided using the satellite 304. The UE 102 then receives 504 the RRCRelease message from the BS 104, which makes UE 102 transition 506 to the idle or inactive state (in case of the inactive state, the UE receives the RRCRelease message with the suspendConfig 1E). A UE that was connected to the network via a serving cell and transitioned to an idle/inactive state is camped on the serving cell, being able to receive information via the serving cell. While in the idle/inactive state, the UE may perform inter-frequency measurements that potentially may indicate a better cell than the serving cell; the UE then reselects the better cell although it may resume the idle/inactive state after switching to the better cell.

After transitioning to the idle/inactive state, the UE 102, which remains camped on cell 124, receives 508, from the BS 104, a first system information block (e.g., SIB4) containing a list of frequency configurations including, for each frequency, a carrier frequency (e.g., dl-CarrierFreq), an SS/PBCH (Physical Broadcast Channel) block Measurement Timing Configuration (SMTC), and a priority. The UE 102 also receives a second system information block (e.g., SIB19) containing a list of neighboring NTN cell configurations including one for the neighboring cell 126 provided by satellite 306. Each neighboring NTN cell configuration may include a carrier frequency (e.g., carrierFreq126), a physical cell identity (e.g., phyCellld126), and other NTN-specific information (e.g., NTN-config 126 conveying satellite ephemeris information of satellite 306).

After acquiring both first and second system information blocks, in order to perform cell reselection for detecting a better cell than the serving cell on which it is camped, the idle/inactive state UE 102 may conduct an inter-frequency measurement on each frequency listed in the first system information block if the frequency has higher priority than the priority of the serving frequency (i.e., the frequency used by the satellite 304 to provide signals in Cell 124, carrierFreq₁₂₄). If all frequencies listed in the first system information block are associated with equal or lower priorities than that of the serving frequency, the UE 102 checks 512 whether the signal quality/strength (e.g., Srxlev that indicates cell selection reception level such as a reference signal received power, RSRP, and Squal that indicates cell selection quality level such as a reference signal received quality, RSRQ) of the serving frequency has dropped below certain respective thresholds (i.e., Srxlev≤S_{nonintraSearchP} or Squal≤S_{nonintraSearchQ}) before conducting measurements on neighboring NTN cell frequencies. Assuming now that the frequency used by the satellite 306 (i.e., ‘carrierFreq₁₂₆’) is included in both the first system information block and the second system information block, and has higher priority than the serving frequency, the UE 102 then determines 514 to conduct the inter-frequency measurement on carrierFreq₁₂₆.

In order to conduct the inter-frequency measurement on carrierFreq₁₂₆, the UE 102 adjusts 516 the measurement timing (e.g., SMTC) of carrierFreq₁₂₄ included in the first system information block based on the estimated distance between the UE 102 and the service satellite (i.e., satellite 304), and the estimated distance between the UE 102 and the neighboring satellite (i.e., satellite 306). The distances between the UE 102 and the satellites may be estimated based on the satellite ephemeris information in the second information block. Note that the above-described scenario assumes that the measurement timing's reference point is the satellite, and if not, since the BS does not compensate the feeder-link delays, the UE has then to take into account the feeder link delay difference while adjusting the measurement timing. UE can know the the feeder-link delay of a cell (either serving or neighbor cell) from the TAInfo block in SIB19 (more speci, in the second information block).

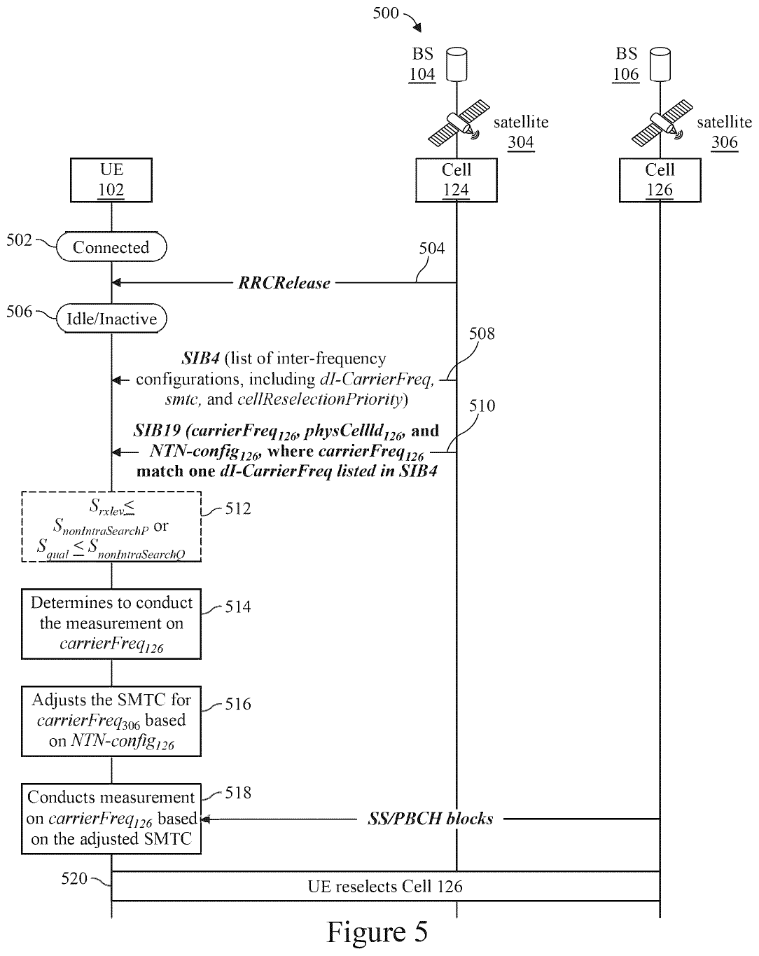

FIG. 6 illustrates a setup in which the UE 102 experiences different propagation delays while communicating via different satellites sending signals to different NTN cells, to explain the timing adjustment. Without timing adjustment, the UE 102 camped (i.e., in idle or inactive state yet continuing to be able to receive information) on cell 124 provided via the satellite 304 expects to receive synchronization signal and PBCH blocks (SSBs) at subframes #2 and #7 as configured for the serving cell. The measurement timing configured for the serving cell accounts for distance DA causing a propagation delay (AtA) to a signal traveling from satellite 304 to the UE 102. Therefore, the UE 102 expects to measure the SSBs at the second subframe counting from t1 (i.e., t₀ +Δt_{A}), based on the configuration provided in the system information block (e.g., the SMTC of the cell 126, which the UE can know from SIB4). However, as the satellite 306 is further away from the UE 102 (i.e., D_{B}>D_{A}), the signals traveling from satellite 306 to UE 102 have a longer propagation delay Δt_{B} (i.e., Δt_{B}>Δt_{A}) than the signals traveling from satellite 304. As a result, the UE 102 misses the SSBs transmitted by the satellite 306 because this SSB arrives later than the expected second subframe counting from t1. In order to perform the measurement, the UE 102 should expect to receive the SSBs transmitted by the satellite 306 at the second subframe counting from t2 (i.e., t₀ +Δt_{B}). The UE 102 needs to delay/shift the measurement timing by Δt_{B}-Δt_{A} for being able to receive the SSBs transmitted by the satellite 306. In order to estimate Δt_{A} and Δt_{B}, the UE 102 needs to know its own GNSS coordinate, and also needs to know the ephemeris information of both the serving satellite 304 and the neighboring satellite 306, which are provided in another system information block (e.g., SIB19). The UE 102 may also need to know the parameters relevant to the common Timing Advance (TA) to estimate Δt_{A} and Δt_{B}, if the propagation delay includes the portion of the feeder link delay. Note that the parameters relevant to the common TA include the common TA value (ta-Common), the drift rate of the common TA value (ta-CommonDrift), and the drift rate variation of the common TA value (ta-CommonDriftVariant), and are also provided in the same system information block as satellite ephemeis information (e.g., SIB19).

As the BS broadcasts the SMTCs for the carrier frequencies in one SIB (i.e., SIB4), and broadcasts the ephemeris/satellite information for the neighboring cells in another SIB (i.e., SIB19), the UE needs to find a linkage/mapping between these two pieces of information in order to be able to adjust the SMTC. For instance, if the UE finds an SMTC for a carrier frequency listed in SIB4, the UE needs to identify one or more other satellites that use the carrier frequency based on the information received in SIB19, so that the UE adjusts the measurement timing for each of these other satellites using that frequency. In the broadcasted satellite information (i.e., SIB 19), the BS indicates a carrier frequency for each of the neighboring NTN cells, thereby making it possible for the UE to find the linkage/mapping between the SMTC listed in SIB4 and the satellite information listed in SIB19. Note that there could be more than one neighboring NTN cell using the same carrier frequency as listed in SIB4. In this case, the UE adjusts the configured SMTC for each of the NTN cells individually based on estimated distances, and then conducts the measurement on each cell using the respectively adjusted SMTC.

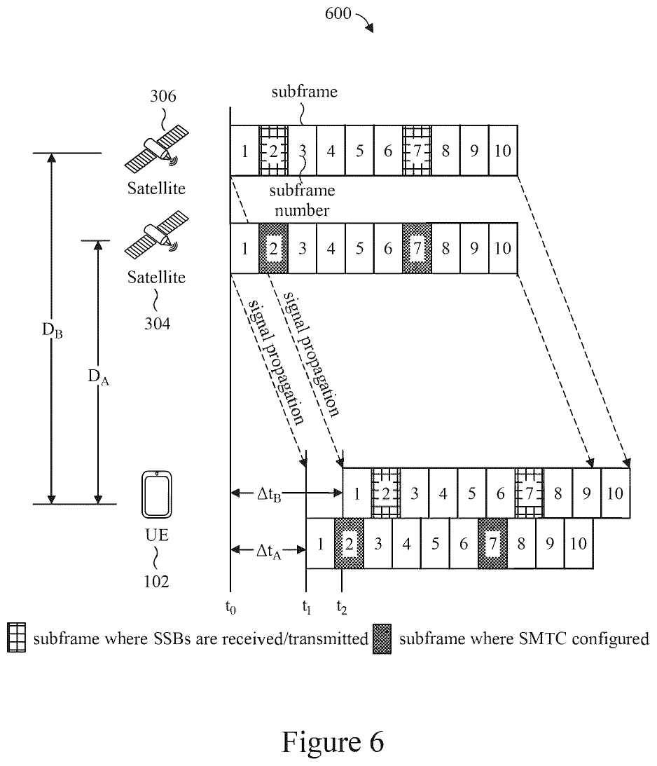

Although UE is typically able to find the linkage between the SMTC in SIB4 and the satellite information in SIB19 via the associated carrier frequency, there are certain cases where the UE cannot find such a linkage. For instance, the UE receives the frequency configuration including the SMTC of a carrier frequency in SIB4, but there is no neighboring NTN cell configuration associated to that carrier frequency in SIB19. This situation may occur especially when the same satellite provides two adjacent NTN cells using two different frequencies, as shown in FIG. 7A. In this case, the BS 104 may skip repeating the satellite 304 configuration by removing/skipping the Cell 125 configuration from SIB19. Similarly, when Cell 125 is the serving cell the BS may remove/skip Cell 124 configuration from SIB19. As a consequence of this removal/omission, the UE may become uncertain about conducting the measurement on the carrier frequency that does not map to any of the neighboring NTN cell configurations.

Another situation in which the UE may fail to find the linkage between the SMTC in SIB4 and the satellite information in SIB19 may occur in the setup illustrated in FIG. 7B. In this setup, both satellite 304 and satellite 306 connect to the same BS 104, and are using the same SMTC for the SSB transmission. Satellite 304 provides Cell 124 using one frequency (freqA) while satellite 306 provides Cell 126 using another frequency (freqB), these frequencies having the same priority. Since both satellites use the same SMTC for the SSB transmission, and are configured with the same priority, the BS may choose not to include the frequency configuration of the frequency used by Cell 126 (i.e., freqB) in SIB4 while using Cell 124 (freq_{A}), in order to save the overhead signaling. Similarly, the BS may choose not to include the frequency configuration of the frequency used by Cell 124 (i.e., freq_{A}) in SIB4 while using Cell 126 (freq_{B}). In both cases, the UE receives information about the frequency used by the neighboring NTN cell in SIB19, together with the ephemeris information of the satellite providing the neighboring NTN cell. However, as the UE is not going to find in SIB4 the corresponding frequency configuration of the carrier frequency listed in the neighboring NTN cell configuration, the conventional UE does not perform the measurement on that carrier frequency, which might degrade UE's mobility performance in the inactive/idle state.

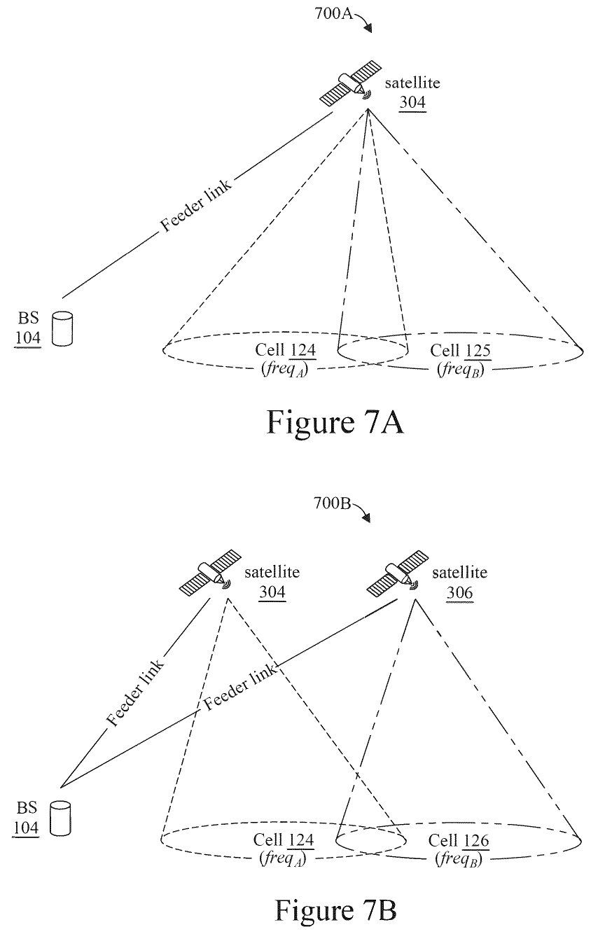

In FIG. 8, an operator attempts to cover a geographical area (e.g., an island) using two satellites: satellite 304 and satellite 306, satellite 304 communicating with UEs within Cell 124 using the frequency ‘freq_{A}’ and with UEs within Cell 125 using ‘freq_{B}’, and satellite 306 communicating with UEs within Cell 126 using the frequency ‘freq_{c}’. Based on the population distribution shown at the bottom of the figure, the operator configures the priority as: freq_{A}=freq_{c} >freq_{B} (that is Cell 124 and Cell 126 have equal priorities, higher than priority of Cell 125) with the intention to achieve the load-balance among these cells and to make UEs camp on either Cell 124 or Cell 126 while in the overlapped areas. As priorities of Cell 124 and Cell 126 are higher that priority of Cell 125, a conventional UE within Cell 125 but not within the areas where Cell 125 overlaps Cell 126 or Cell 124 seeks to measure synchronization signals of freq_{A} and freq_{c}, without being actually able to use Cell 124 or Cell 126. As a result, a large portion of the UEs served by Cell 125 consume a lot of power unnecessarily, as a NTN cell is typically larger and less overlapped with neighboring cells (compared to a TN cell).

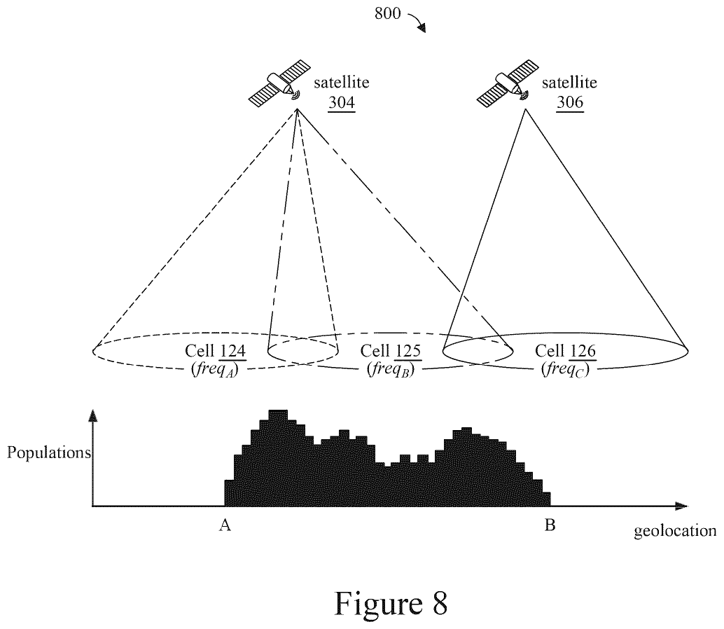

Next, techniques overcoming the above-identified problems related to cell reselection, that is, with NTN inter-frequency measurement for the UE operating in idle or inactive state, are discussed with reference to FIGS. 9-11. Similar events in FIGS. 9-11 are labeled with the similar reference numbers, with differences discussed below where appropriate. For example, event 907 is similar to event 1007, event 508 is similar to event 1008, event 510 is similar to events 910 and 1110, event 514 is similar to events 1014 and 1114, event 518 is similar to event 918, and event 520 is similar to event 920. To simplify the following description, the term “inactive state” is used and can represent the RRC_INACTIVE or RRC_IDLE state, and the term “connected state” is used and can represent the RRC_CONNECTED state.

FIG. 9 is a messaging diagram 900 of an embodiment operating in the setup illustrated in FIG. 7A, with an idle/inactive UE conducting a measurement on a carrier (candidate) frequency that is not included in any neighboring NTN cell configuration. The messaging diagram 900 in FIG. 9 is based on the messaging in FIG. 5, with the differences discussed below. In FIG. 9, the BS 104 communicates with UEs located inside Cell 124 and inside Cell 125 via the same satellite 304 but using different frequencies. The UE 102 camped (i.e., in an idle/inactive state) on Cell 124 can communicate with the BS 104 via the satellite 304 using freq_{A}. Since UEs in Cell 124 and Cell 125 communicate via the same satellite (e.g., satellite 304) with the BS 104, the BS 104 determines 907 not to include the neighboring NTN cell configuration for Cell 125 in the system information block (e.g., SIB19) conveying (using Cell 124) the list of neighboring NT cell configurations. After transitioning 506 to the idle/inactive state, the UE 102 in Cell 124 receives 508 a first system information block (e.g., SIB4) containing the frequency configuration of the carrier frequency, f_{B}, used by Cell 125, and also receives 910 a second system information block (e.g., SIB19) not containing the neighboring NTN cell configuration for Cell 125.

After determining 512 and 514 to conduct the inter-frequency measurement on the frequency fp, the UE 102 further detects 915 that the frequency f does not match to any carrier frequency (i.e., carrierFreq) in the neighboring NTN cell configurations included in the second system information block (e.g., SIB19). The UE 102 then conducts 918 the inter-frequency measurement on the frequency f_{B} based on the SMTC included in the frequency configuration for frequency f_{B} based on the assumption that the frequency f_{B} is emitted from the same satellite that is currently serving the UE 102 (i.e., satellite 304). Based on the measurement results the UE may reselect 920 (thus camp on) Cell 125.

In another embodiment, if the UE detects 915 that the frequency f_{B} does not match to any carrier frequency in the neighboring NTN cell configurations included in the second system information block, the UE determines not to conduct the measurement on f_{B}. Yet in another embodiment, if the UE detects 915 that the frequency f_{B} does not match to any carrier frequency in the neighboring NTN cell configurations included in the second system information block, the UE may determine adjusted SMTCs by adjusting the SMTC configured for f_{B} based on each of the neighboring NTN cell configurations included in the second system information block, and then conducts the measurement on f_{B} based on each of the adjusted SMTCs. The UE adjusts STMC as explained above based on FIG. 6.

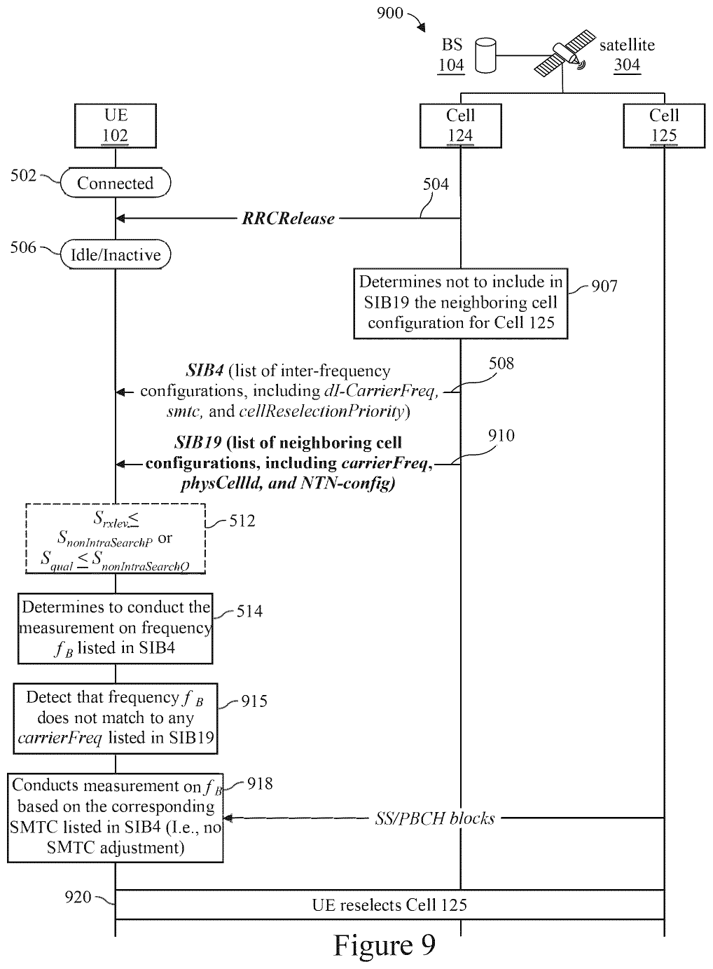

FIG. 10 is a messaging diagram 1000 of an embodiment operating in the setup illustrated in FIG. 7B, with an idle/inactive UE conducting a measurement on a carrier frequency that is not included in the list of frequency configurations but it is associated to a neighboring NTN cell configuration. The messaging diagram 1000 in FIG. 10 is based on the messaging in FIG. 5, with the differences discussed below. In FIG. 10, the BS 104 communicates with UEs located inside Cell 125 and inside Cells 125 and 126 via satellite 304 and satellite 306, respectively, using different frequencies. As the same BS (i.e., BS 104) manages both Cell 124 and Cell 125, the BS 104 determines to configure the same SMTC and same priority on both frequencies used by Cell 124 and Cell 125, and therefore determines 1007 not to include the frequency configuration for the frequency used by Cell 125 in the system information block (e.g., SIB4) transmitted via Cell 124. As a result, after transitioning 506 to the idle/inactive state, the UE 102 camped on Cell 124 receives 1008 a first system information block (e.g., SIB4) not containing the frequency configuration of the frequency used by Cell 125 (i.e., carrierFreq₁₂₆), and receives 510 a second system information block (e.g., SIB19) containing the neighboring NTN cell configurations including the frequency used in Cell 125 (i.e., carrierFreq₁₂₆).

The UE 102 then detects 512 that the signal quality/strength on the serving frequency has dropped below predetermined thresholds (i.e., Srxlev≤S_{nonIntraSearchP} Or Squal≤S_{nonintraSearchQ}) and hence determines to conduct the inter-frequency measurement on the frequencies that have equal or lower priorities than the serving frequency. Note that the UE 102 always needs to conduct the inter-frequency measurement on the frequencies that have higher cell reselection priorities than that of the serving frequency, regardless of the signal quality/strength of the serving frequency.

After the UE 102 has determined (due to poor serving signal quality) to conduct the inter-frequency measurement on the frequencies that have equal or lower priorities than the serving frequency, the UE 102 detects/finds 1013 that a carrier frequency included in the neighboring NTN cell configuration (in SIB19) has no corresponding frequency configuration in SIB4. As a result, the UE 102 determines to conduct the measurement on this SIB19-only carrier frequency based on the frequency configuration of the serving cell, where the frequency configuration of the serving cell includes the measurement timing (SMTC) for the serving frequency. The UE 102 then adjusts 516 the measurement timing of the serving frequency based on an estimated distance between the UE and the serving cell's satellite (e.g., satellite 304), and the estimated distance between the UE and the neighboring cell's satellite (e.g., satellite 306). The UE adjusts measurement timing as explained above based on FIG. 6. With the adjusted measurement timing, the UE 102 then conducts 518 the measurement on the SIB19-only frequency. Based on the measurement result and a cell reselection criterion, the UE 102 may reselect 520 the neighboring cell using the SIB19-only frequency as its serving cell.

In another embodiment, if the UE 102 detects/finds 1013 that the carrierFreq₁₂₆ included in the neighboring cell configuration (in SIB19) has no corresponding frequency configuration in SIB4, the UE 102 does not conduct a measurement on carrierFreq₁₂₆.

Yet in another implementation, if the UE 102 detects/finds 1013 that the carrierFreq₁₂₆ included in the neighboring cell configuration (in SIB19) has no corresponding frequency configuration in SIB4, the UE 102 determines to conduct the measurement on carrierFreq₁₂₆ based on the assumption that the SSB periodicity is 5 ms.

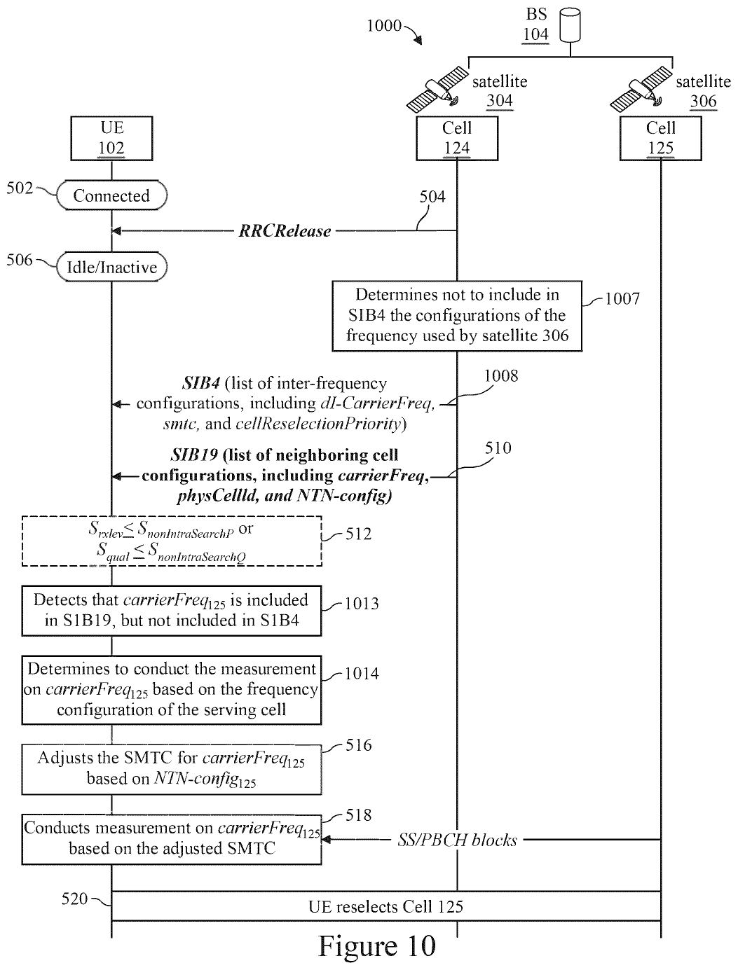

FIG. 11 is a messaging diagram 1100 of an embodiment operating in the setup illustrated in FIG. 8, with an idle/inactive UE conducting a measurement on a higher-priority frequency (higher than the priority of the serving frequency) only if the UE is located within the cell using that frequency. The messaging diagram 1100 in FIG. 11 is based on the messaging in FIG. 5, with the differences discussed below. The UE 102 initially in Cell 124 connects 502 to the BS 104 via the satellite 304. After transitioning 506 to the idle/inactive state, the UE 102 receives 508, from the BS 104, a first system information block (e.g., SIB4) containing the frequency configurations, and then receives 1110, from the BS 104, a second system information block (e.g., SIB19) containing the neighboring NTN cell configurations, where the neighboring NTN cell configurations include a cell configuration of the cell 126 provided by the BS 106. Here, the cell configuration of Cell 126 may already include a reference location (e.g., the central location) of Cell 126, and then a radius (or other pertinent information) determines the coverage area of Cell 126.

After acquiring both SIB4 and SIB19, the UE 102 detects/finds 1111 that the carrier frequency used in Cell 126 (i.e., carrierFreq₁₂₆) matches at least one dl-CarrierFreq listed in SIB4, where the matched dl-CarrierFreq has higher priority than the serving frequency. If the UE 102 were a legacy UE, the UE would immediately conduct the measurement on carrierFreq₁₂₆. However, in this embodiment, the UE 102 detects/finds 1117A that the UE 102 is not within the coverage of the Cell 126, based on UE's location information, the reference location of Cell 126 (obtained from SIB19), and the radius of Cell 126 (obtained from SIB19). Therefore, the UE 102 determines 1114A not to conduct the measurement on carrierFreq₁₂₆, to save UE's power.

If later, due to the UE mobility or the satellite mobility, the UE 102 detects/finds 1117B that the UE 102 is now within the coverage of the Cell 126 based on UE's location information, the reference location of Cell 126, and the radius of Cell 126, the UE 102 then determines 1114 to conduct the measurement on carrierFreq₁₂₆.

In the scenario illustrated in FIG. 11, the coverage area of the higher-priority cell or the neighbor cell is specified. However, in another embodiment, a measurement area (less than its coverage area) of the lower-priority cell or the serving cell may be specified so the UE is not going to measure the higher-priority or the neighbor frequency as long as it is located within the measurement area of the lower-priority or the serving cell.

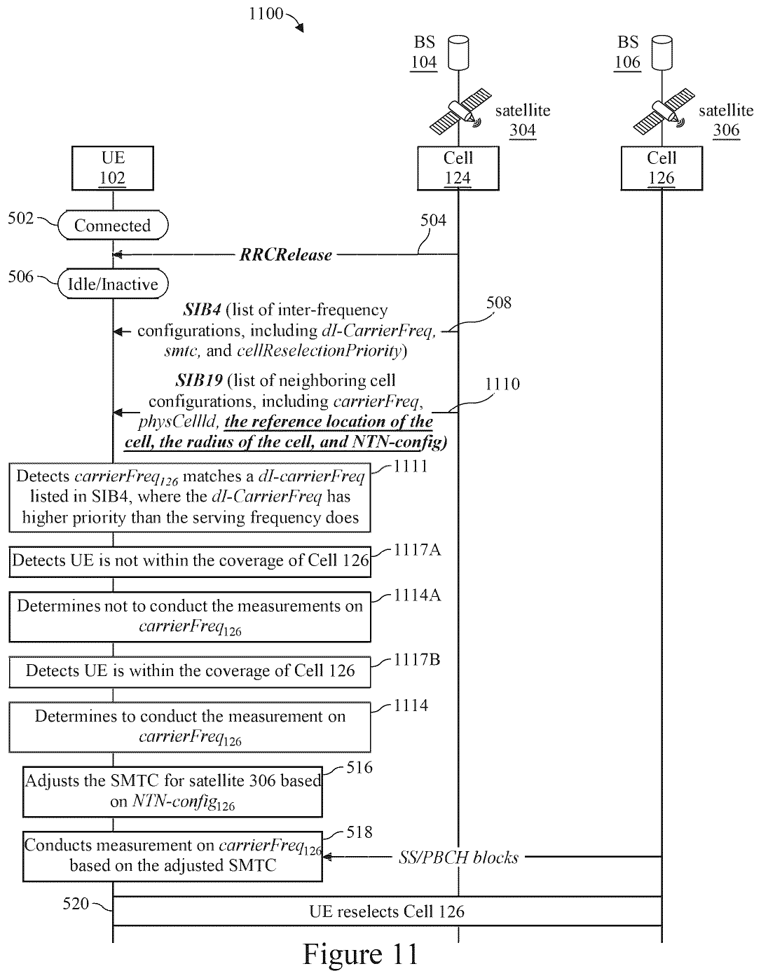

FIG. 12 is a flow diagram of a method 1200 according to which a UE (e.g., the one in FIG. 9) is able to conduct a measurement on a carrier frequency not included in any neighboring NTN cell configuration. The UE receives 1208 and 1210, from the BS, a first system information block (e.g., SIB4) including a list of frequency configurations, and a second system information block (e.g., SIB19) including a list of neighboring NTN cell configurations, respectively.

The UE then determines 1214 to conduct a measurement on a candidate frequency listed in the list of frequency configurations (for example, because the candidate frequency has higher priority than the serving frequency, and/or the signal quality/strength of the serving cell has dropped below one or more predefined thresholds).

After the UE determines to conduct the measurement on a candidate frequency, the UE determines 1215 whether the candidate frequency is specified in any neighboring cell configuration listed in the second system information block.

If the UE determines that indeed the candidate frequency is included in a neighboring cell configuration (i.e., “YES” branch of 1215), the UE adjusts 1216 the measurement timing (e.g., SMTC) associated with the candidate frequency in the first information block, in view of the signal propagation difference between the serving cell and to the neighbor cell (which is a cell not shown in FIG. 9). The UE then conducts 1218B the measurement on the candidate frequency using the adjusted measurement timing.

On the other hand, if the UE determines that the frequency to be measured is not included in any neighboring cell configuration listed in the second system information block (i.e., “NO” branch of 1215), the UE conducts 1218A the measurement on the candidate frequency based on the measurement timing (e.g., SMTC) included in the list of frequency configurations without any adjustment.

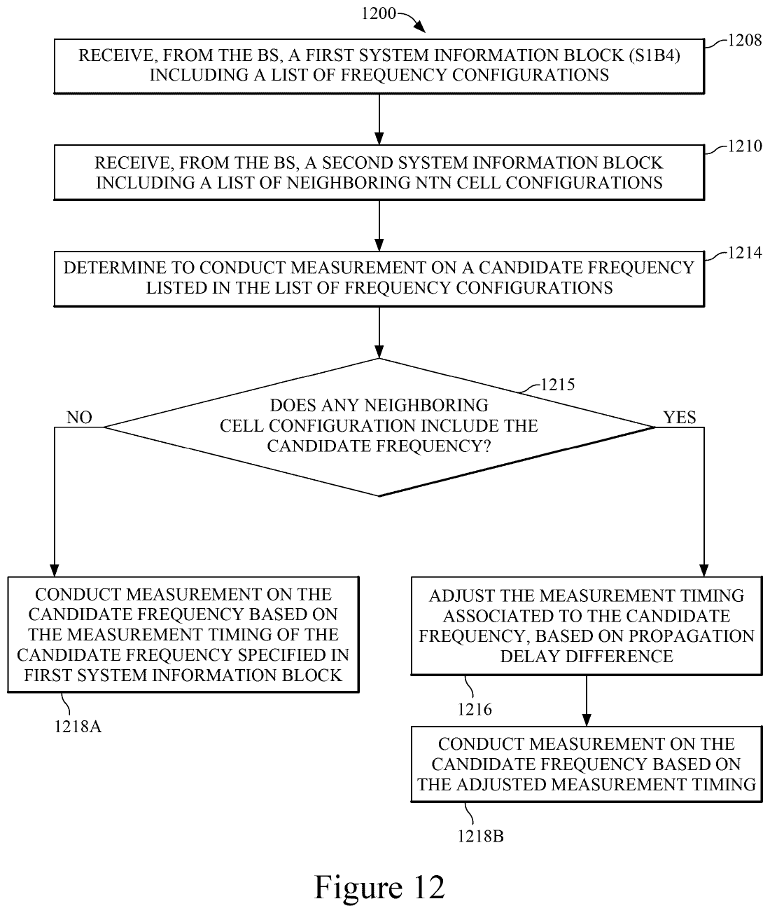

FIG. 13 is a flow diagram of a method 1300 performed by a UE (e.g., the one in FIG. 10), for conducting a measurement on a candidate frequency that is not included in the frequency configurations. As in the method 1200, in the method 1300, the UE first receives 1208, from the BS, a first system information block (e.g., SIB4) including a list of frequency configurations, and then receives 1210 a second system information block (e.g., SIB19) including a list of neighboring NTN cell configurations.

The UE then determines 1312 to perform measurement on a carrier frequency that is listed in the first system information block and has an equal or lower priority than that of the serving frequency, in response to the signal quality/strength of the serving cell dropping below predefined threshold(s). Following the determination at block 1312, the UE conducts 1319 the measurement on the carrier frequencies. Note that steps 1312 and 1319 are optional as there may be no carrier frequency listed in the first system information block with an equal or lower priority than that of the serving frequency.

While the UE is conducting measurements on the lower-priority carrier frequencies, or after the UE has conducted such measurements if there is any carrier frequency listed in the first system information block with an equal or lower priority than that of the serving frequency, the UE determines 1313 whether the second system information block includes a neighboring cell configuration whose carrier frequency is not equal to the serving frequency and is not specified by any frequency configuration included in the first system information block.

If the UE determines that indeed the second system information block includes a neighboring cell configuration whose carrier frequency is not equal to the serving frequency and is not specified by any frequency configuration included in the first system information block (i.e., “YES” branch of 1313), the UE determines 1314 to conduct a measurement on this candidate frequency based on a measurement timing (e.g., SMTC) associated to the serving frequency and specified in the first information block. The UE adjusts 1316 the measurement timing of the serving frequency to account for the propagation delay difference between the cells, using the satellite ephemeris in the second information block. Finally, the UE 1318 conducts the measurement on the candidate frequency that is not equal to the serving frequency and is not specified by any frequency configuration included in the first system information block, based on the adjusted measurement timing.

If however, the UE determines that the second system information block does not include a neighboring cell configuration whose candidate frequency is not equal to the serving frequency and is not specified by any frequency configuration included in the first system information block (i.e., “NO” branch of 1313), the UE takes 1390 no further action.

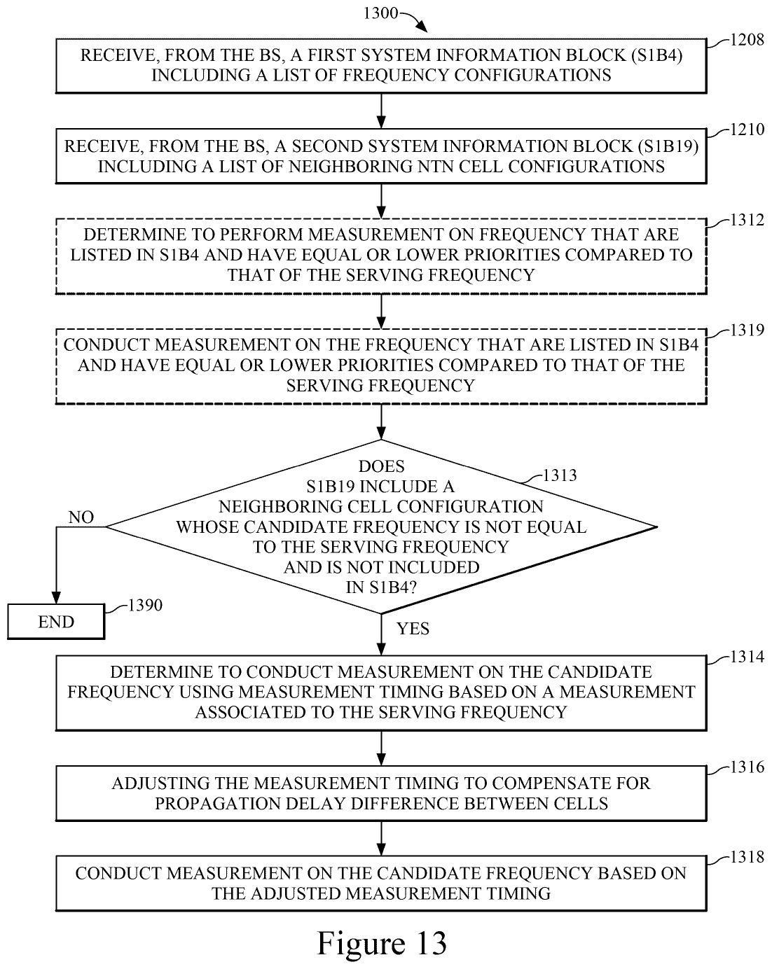

FIG. 14 is a flow diagram of a method 1400 according to which a UE (e.g., the one in FIG. 11) conducts a measurement on a higher-priority frequency (higher priority than the priority of the serving frequency) depending on whether the UE is located within the higher-priority cell's coverage. The UE first receives 1208, from the BS, a first system information block (e.g., SIB4) including a list of frequency configurations. The UE also receives 1410, from the BS, a second system information block (e.g., SIB19) including a list of neighboring NTN cell configurations, where at least one of the neighboring NTN cell configurations specifies a cell coverage area (e.g., includes a reference location and a cell radius). The reference location can be, for instance, the central location/coordinate of the neighboring cell, and the coverage area may be specified in a different manner than by a cell radius.

The UE then determines 1411 that a candidate frequency listed in the first information block (i.e., the list of frequency configurations) has a higher priority than the serving frequency. The UE then determines 1417 whether the UE is within the coverage area of the neighboring cell using the candidate frequency based on the UE's location and the cell coverage (if) specified in the second information block.

If the UE determines 1417 that indeed the UE is within the coverage area of the neighboring cell (i.e., “YES” branch of 1417) using the candidate frequency (or if the UE is not able to make such a determination due to insufficient information), the UE adjusts 1216 the measurement timing (e.g., SMTC) associated to the candidate frequency in the first information block to account for the propagation delay difference between the serving cell and the neighboring cell. The UE then conducts 1218B a measurement on the candidate frequency using the adjusted measurement timing.

On the other hand, if the UE determines 1417 that the UE is not within the coverage of the neighboring cell using the candidate frequency (i.e., “NO” branch of 1417), then the UE determines 1414A to halt the measurement on the candidate frequency, until the UE is within the coverage of the neighboring cell using that frequency thereby preventing waste of energy. That is, after 1414A, the flow loops back to 1417.

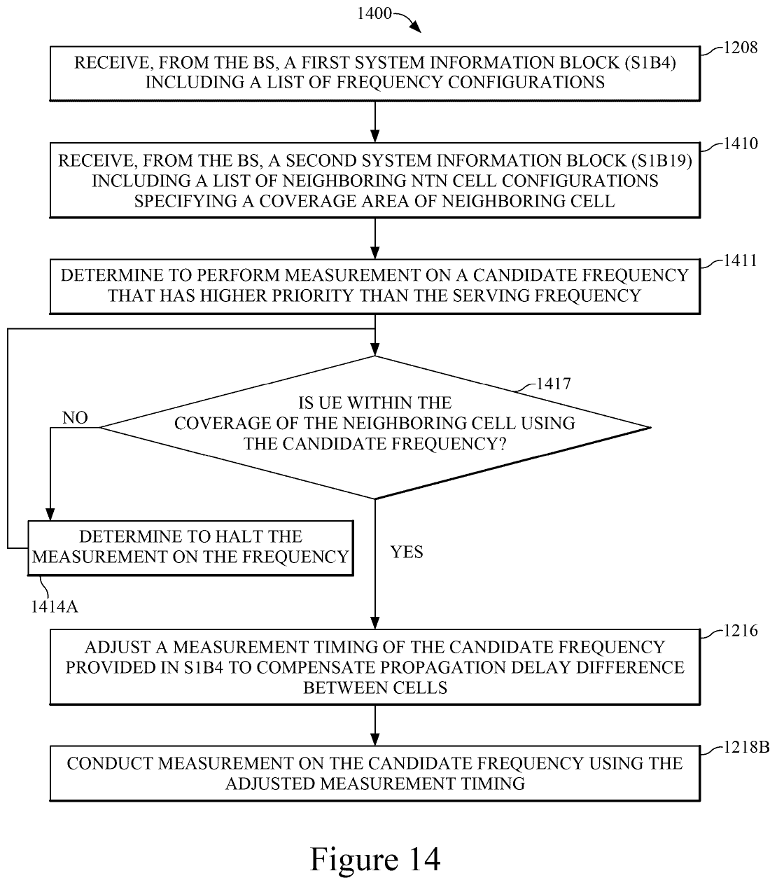

FIG. 15 is a flow diagram of a method 1500 according to which an NE (e.g., a BS such as the one in FIG. 9) may reduce the list of neighboring NTN cell configurations for a serving cell. The BS first determines 1501 a list of frequency configurations, where each frequency configuration includes at least a (carrier) frequency and a measurement timing (e.g., SMTC). The BS also determines 1503 a list of neighboring NTN cell configurations, where each neighboring cell configuration includes at least a (carrier) frequency, a physical cell identity, and ephemeris information of a satellite used to provide the cell.

The BS then excludes 1505 a neighboring cell configuration of an NTN cell from the list of neighboring NTN cell configurations, if the NTN cell is provided by the same satellite providing the serving cell with same priority as the serving cell. After that, the BS broadcasts 1508 a first system information block (e.g., SIB4) including the list of frequency configurations, and broadcasts 1510 a second system information block (e.g., SIB19) including the list of neighboring NTN cell configurations as potentially modified.

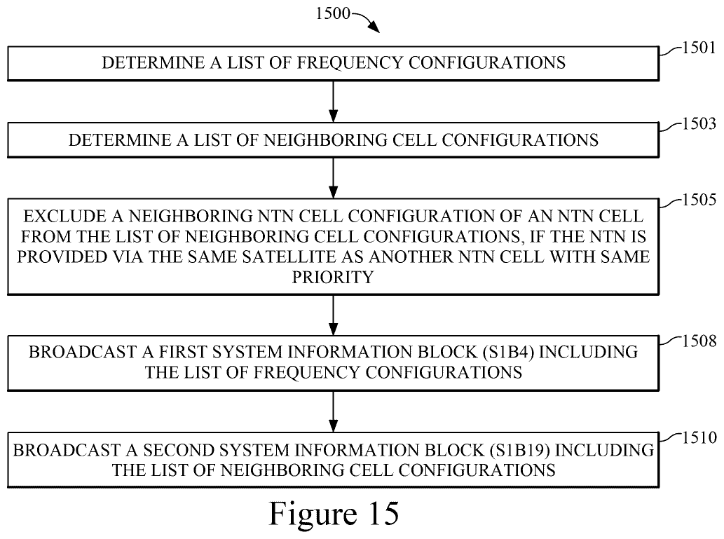

FIG. 16 is a flow diagram of a method 1600 according to which an NE (e.g., a BS such as the one in FIG. 10) may reduce the list of the frequency configurations. The method 1600 is similar to the method 1500, with the differences described below. After determining 1501 the list of frequency configurations and 1503 the list of the neighboring NTN cell configurations, the BS excludes 1605 a frequency configuration from the list of frequency configurations, if the frequency configuration indicates the same priority and the same measurement timing (e.g., SMTC), that is via the same satellite, as for the serving cell. The BS then broadcasts 1608 a first system information block (e.g., SIB4) including the (now unmodified) list of frequency configurations, and broadcasts 1610 a second system information block (e.g., SIB19) including the list of neighboring NTN cell configurations as modified.

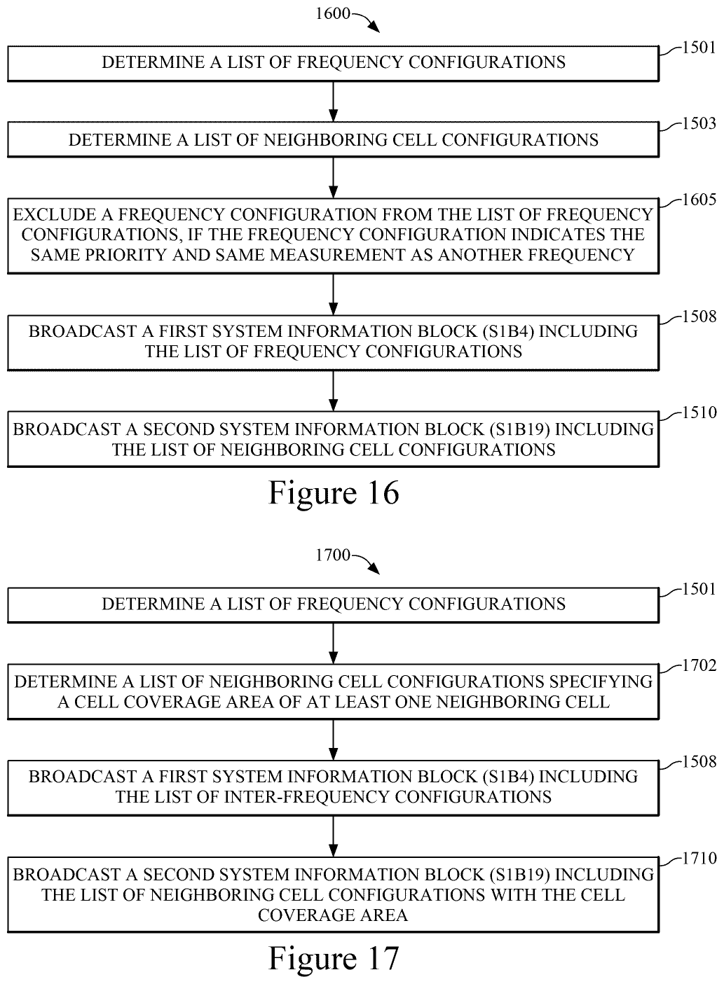

FIG. 17 is a flow diagram of a method 1700 according to which an NE (e.g., a BS such as the one in FIG. 11) includes cell coverage information in the list of neighboring NTN cell configurations. As in the methods 1500 and 1600, the BS first determines 1501 a list of frequency configurations, where each frequency configuration includes at least a (carrier) frequency and a measurement timing (e.g., SMTC). The BS then determines 1703 a list of neighboring NTN cell configurations specifying a cell coverage area for at least one neighboring cell (e.g., a cell reference location and a radius). The cell reference location may be a central location or a central coordinate of the neighboring cell, and other parameters than a radius may be used to specify the cell coverage area (e.g., shape and size).

The BS broadcasts 1608 the first system information block (e.g., SIB4) including the list of frequency configurations, and then broadcasts 1710 a second system information block (e.g., SIB19) including the list of neighboring NTN cell configurations as prepared at 1703.

The techniques presented in this section have wide-ranging applicability across a diverse spectrum of telecommunication systems, network architectures, and communication standards. For instance, consider the 3GPP, a standards organization responsible for defining numerous wireless communication standards, particularly those related to the evolved packet system (EPS) commonly known as long-term evolution (LTE) networks. Evolved iterations of LTE, like fifth-generation (5G) networks, can support a plethora of services and applications, including but not limited to web browsing, video streaming, Voice over Internet Protocol (VoIP), mission-critical applications, multi-hop networks, real-time remote operations (e.g., tele-surgery), and more.

Hence, the embodiments described here can be implemented across various network technologies, including, but not restricted to, 6G, 5G, fourth-generation (4G), third-generation (3G), and diverse network architectures. Moreover, the techniques described herein can be applied to different types of links, whether it's a downlink, uplink, peer-to-peer link, or any other connection type.

The selection of the specific telecommunication standard, network architecture, or communication standard hinges on the particular application and the overall system design constraints imposed. While these disclosures may illustrate certain aspects in the context of a 6G, 5G or LTE system for clarity, one skilled in the art would recognize that these teachings are equally adaptable to other technological frameworks, networks, components, signaling methods, and so forth. In summary, the adaptability and versatility of the techniques discussed in this section make them suitable for a wide array of telecommunication scenarios, regardless of the specific terminology or technology involved.

Numerical adjectives “first”, “second”, and “third” used in the above embodiments do not imply any order (are not ordinals) but are markers to distinguish separate instances of similar elements. References to the singular (e.g., “a” or “an”, “the”) should include the plural unless clearly indicated otherwise.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-15. (canceled)

16. A wireless communication method performed by a user equipment, UE camped on a serving cell, for inter-frequency measurement, the method comprising:
receiving a first system information, SI, block including a list of inter-frequency configurations;
receiving a second SI block including a list of neighboring non-terrestrial network, NTN cell configurations; and
measuring a first signal on a first inter-frequency candidate specified in the list of inter-frequency configurations when the list of neighboring NTN cell configurations includes a neighbor NTN cell configuration associated with the first inter-frequency candidate.

17. The wireless communication method of claim 16, wherein
each of the inter-frequency configurations includes a frequency, a priority, and measurement timing information of a cell, and/or
each of the neighboring NTN cell configurations of a neighbor NTN cell includes a neighbor NTN cell frequency, a neighboring NTN cell identifier, and satellite ephemeris information of a satellite used for the neighbor NTN cell.

18. The wireless communication method of claim 16, wherein the first SI block is an SIB4 as defined in 3GPP technical specifications.

19. The wireless communication method of claim 16, wherein the second SI block is an SIB19 as defined in 3GPP technical specifications.

20. The wireless communication method of claim 16, further comprising:
selecting the first inter-frequency candidate based on respective priorities associated with frequencies specified in the first SI block.

21. The wireless communication method of claim 16, wherein the measuring of the first inter-frequency candidate associated with a priority lower than a serving cell frequency priority is triggered by detecting a signal quality on the serving cell below a predetermined threshold.

22. The wireless communication method of claim 16, further comprising:
adjusting timing of the measuring the first signal using the neighbor NTN cell configuration associated with the inter-frequency candidate.

23. The wireless communication method of claim 16, further comprising:
measuring a second signal on a second inter-frequency candidate other than a frequency used by a serving cell on which the UE is camped, when the second inter-frequency candidate is specified only in the first SI block or only in the second SI block.

24. The wireless communication method of claim 23, wherein
the second SI block specifies a measurement area associated with the second inter-frequency candidate, and
the measuring of the second signal is performed when the UE is located within the measurement area.

25. The wireless communication method of claim 24, wherein the measurement area is specified by a reference location and a radius.

26. The wireless communication method of claim 23, wherein the measuring of the second signal occurs if a priority of the second inter-frequency candidate is higher than a priority of the frequency used by the serving cell.

27. A user equipment, UE, in a wireless communication system, the UE comprising:
a transceiver configured to receive
a first system information, SI, block,
a second SI block, and
a downlink signal on an inter-frequency candidate; and
a processor configured
to retrieve a list of inter-frequency configurations from the first SI block, and a list of neighboring non-terrestrial network, NTN cell configurations from the second SI block, and
to measure the downlink signal received on the inter-frequency candidate when the list of inter-frequency configurations includes the inter-frequency candidate, and the list of neighboring NTN cell configurations includes a neighbor NTN cell configuration associated with the inter-frequency candidate.

28. The UE of claim 27, further comprising:
a computer readable recording medium storing executable codes that configure the processor to retrieve the list of inter-frequency configurations from the first SI block, and the list of neighboring NTN cell configurations from the second SI block, and to measure the downlink signal received on the inter-frequency candidate when the list of inter-frequency configurations includes the inter-frequency candidate, and the list of neighboring NTN cell configurations includes a neighbor NTN cell configuration associated with the inter-frequency candidate.

29. A wireless communication method performed by network entity, NE, the method comprising:
determining a list of inter-frequency configurations and a list of neighboring non-terrestrial network, NTN, cell configurations;
modifying the list of inter-frequency configurations and/or the list of neighboring NTN cell configurations by:
excluding a frequency configuration from the list of inter-frequency configurations when the frequency configuration indicates a same priority and a same measurement timing as another frequency configuration from the list of inter-frequency configurations, and/or
excluding a neighboring NTN cell configuration corresponding to an NTN cell from the list of neighboring NTN cell configurations when the NTN cell is provided via a same satellite as another NTN cell, with a same reselection priority; and
broadcasting the list of inter-frequency configurations and/or the list of neighboring cell NTN configurations as modified.

30. The wireless communication method of claim 29, wherein the broadcasting includes broadcasting a system information block SIB4 as defined in 3GPP technical specifications, the system information block SIB4 including the list of inter-frequency configurations.

31. The wireless communication method of claim 29, wherein the broadcasting includes broadcasting a system information block SIB19 as defined in 3GPP technical specifications, the system information block SIB19 including the list of neighboring cell NTN configurations.

32. The wireless communication method of claim 29, further comprising:
specifying, in the list of neighboring NTN cell configurations, a measurement area associated with an NTN cell.

33. The wireless communication method of claim 32, wherein the specifying of the measurement area includes specifying a reference location and a radius.

34. A network entity, NE, in a wireless communication system, the NE comprising:
a transceiver configured to broadcast wireless communications; and
a processor configured
to determine a list of inter-frequency configurations and a list of neighboring non-terrestrial network, NTN, cell configurations;
to modify the list of frequency configurations and/or the list of neighboring NTN cell configurations by:
excluding a frequency configuration from the list of frequency configurations when the frequency configuration indicates a same priority and a same measurement timing as another frequency configuration from the list of frequency configurations, and/or
excluding a neighboring NTN cell configuration corresponding to an NTN cell from the list of neighboring NTN cell configurations when the NTN cell is provided via a same satellite as another NTN cell, with a same reselection priority; and
to trigger the transceiver to broadcast the list of frequency configurations and/or the list of neighboring neighboring NTN cell configurations as modified.

35. The NE of claim 34, further comprising:
a computer readable recording medium storing executable codes that configure the processor to determine and to modify the list of frequency configurations and/or the list of neighboring NTN cell configurations.
